(19) United States
(12) Patent Application Publication
(10) Pub. No.: US 2015/0207958 A1
(43) Pub. Date: Jul. 23, 2015

(54) APPARATUS, METHOD, AND MEDIUM

(71) Applicant: CANON KABUSHIKI KAISHA, Tokyo (JP)

(72) Inventor: Misae Tasaki, Tokyo (JP)

(21) Appl. No.: 14/598,163

(22) Filed: Jan. 15, 2015

(30) Foreign Application Priority Data
Jan. 22, 2014 (JP) 2014-009610

(51) Int. Cl. H04N 1/60; G06K 15/10

(52) U.S. Cl. CPC H04N 1/6033; G06K 15/102; H04N 1/6058

(57) ABSTRACT

An apparatus that creates a color profile includes: a color reproduction target value acquiring unit that acquires a plurality of color reproduction target values; an output device color reproduction region acquiring unit that acquires a color reproduction region of an output device; a condition acquiring unit that acquires a condition to select the color reproduction target value; a color reproduction target value selecting unit that selects the color reproduction target value that satisfies the condition out of the plurality of color reproduction target values; and color profile creating units that create, based on the acquired color reproduction region of the output device and the selected color reproduction target value, the color profile in which the color reproduction target value is present in the color reproduction region of the output device.

### BACKGROUND OF THE INVENTION

1. Field of the Invention

The present invention relates to an apparatus, a method, and a medium. Specifically, the present invention relates to an apparatus, a method, and a medium that create a color profile.

2. Description of the Related Art

Conventionally, known are methods in which a user him/herself creates a color profile satisfying the image quality that the user thinks is preferable. For example, to acquire a desired image quality in accordance with outputs such as a printer, a medium, and an ink that a user possesses, the user him/herself may create a color profile in some cases.

Herein, an outline of a method of creating a color profile will be explained. Creation of a color profile requires a color reproduction region of an output device, and a color reproduction target value serving as a target image quality.

The color reproduction region of the output device is determined based on CIEL*a*b*values corresponding to RGB values in an output device dependent color space. The color reproduction region of the output device can be acquired by printing a patch image in accordance with previously set patch image data, and performing color measurement of the printed patch image using a colorimetric device. The patch image is created using a known color material activity ratio.

The color reproduction target value is composed of CIEL*a*b*values corresponding to RGB values in an input device dependent color space. The number of pieces of data of the color reproduction target value is N³ (N: integer), such as 729, 1728, or 4096. The color reproduction target value stored in advance in an apparatus that creates a color profile is used. Alternatively, a color reproduction target value may be acquired by printing, and performing color measurement on, a patch image having a target image quality that a user thinks is preferable and created using the known color material activity ratio.

A color profile having RGB values in the output device dependent color space corresponding to RGB values in the input device dependent color space can be obtained by performing a color region compression process based on the acquired color reproduction target value and the color reproduction region of the output device. With the method as described above, in response to the trend that the user him/herself creates a color profile, not only general-purpose commercial color measurement devices but also products of color image output devices with a built-in colorimetric device, as being represented by the latest color inkjet printers, become available on the market. Further, in recent years, techniques of creating a profile in various output devices are proposed.

Japanese Patent Laid-Open No. 2008-219791 describes selecting a virtual color reproduction region approximate to a color reproduction region of an output device, and using an input profile in which a color reproduction target value corresponding to the virtual color reproduction region is described. Moreover, Japanese Patent Laid-Open No. 2008-219791 describes temporarily converting input image data into data in the abovementioned virtual color reproduction region, and mapping the converted data to the color reproduction region of the output device. This allows the uniform color tone to be reproduced regardless of the size or the like of the color reproduction region of the output device.

### SUMMARY OF THE INVENTION

Japanese Patent Laid-Open No. 2008-219791 discloses a technique in which a color profile is created using a color reproduction target value that is a parameter associated with a color reproduction region of an output device. This technique makes it comparatively easy to create a profile in accordance with the color reproduction region of the output device. However, the invention disclosed in Japanese Patent Laid-Open No. 2008-219791 is such that a virtual color reproduction region corresponding to a color reproduction target value is selected depending on the color reproduction region of the output device. This makes it impossible to use various color reproduction target values for the size and the shape of the color reproduction region and the color adjustment, for example, the color reproduction that a user desires.

The present invention is made in view of the abovementioned problem. The present invention aims to provide an apparatus and a method that are capable of creating a color profile based on a color reproduction target value selected from multiple color reproduction target value candidates.

The present invention provides an apparatus that creates a color profile, and the apparatus includes: a color reproduction target value acquiring unit that acquires a plurality of color reproduction target values; an output device color reproduction region acquiring unit that acquires a color reproduction region of an output device; a condition acquiring unit that acquires a condition to select the color reproduction target value; a color reproduction target value selecting unit that selects the color reproduction target value that satisfies the condition out of the plurality of color reproduction target values; and a color profile creating unit that creates, based on the acquired color reproduction region of the output device and the selected color reproduction target value, the color profile in which the color reproduction target value is present in the color reproduction region of the output device.

With the present invention, a color profile that satisfies an image quality suitable for a usage purpose of a user or a scene can be created.

Further features of the present invention will become apparent from the following description of exemplary embodiments (with reference to the attached drawings).

### BRIEF DESCRIPTION OF THE DRAWINGS

FIG. 1A and FIG. 1B are graphs illustrating color reproduction regions of sRGB and AdobeRGB;

FIG. 2 is a block diagram illustrating a schematic configuration an entire system according to a first embodiment;

FIG. 3A and FIG. 3B are explanation views of an output device 208 according to the first embodiment;

FIG. 4 is a block diagram illustrating a detailed configuration of a color profile creating unit 204 according to the first embodiment;

FIG. 5A and FIG. 5B are explanation views of color reproduction target value candidates;

FIG. 6 is a flowchart of color profile creation processing according to the first embodiment;

FIG. 7A and FIG. 7B are graphs indicating L*a*b*values of W, Bk, R, G, B, C, M, and Y in an L*a*b* coordinates system;

FIG. 8A and FIG. 8B are graphs illustrating a*b*values of R, G, B, C, M, and Y in a*b* coordinates system;

FIG. 9A is a diagram showing the relationship of FIG. 9A-1 and FIG. 9A-2;

FIG. 9A-1, FIG. 9A-2, FIG. 9B, and FIG. 9C are flowcharts of color reproduction target value determination processing according to the first embodiment;

FIG. 10 is a view illustrating an UI example according to the first embodiment;

FIG. 11 is a block diagram illustrating a configuration of a part of a system according to a second embodiment; and

FIG. 12 is a block diagram illustrating a detailed configuration of a color profile creation device 220 and a target color reproduction region extraction device 230 according to the second embodiment.

### DESCRIPTION OF THE EMBODIMENTS

### First Embodiment

### (System Configuration)

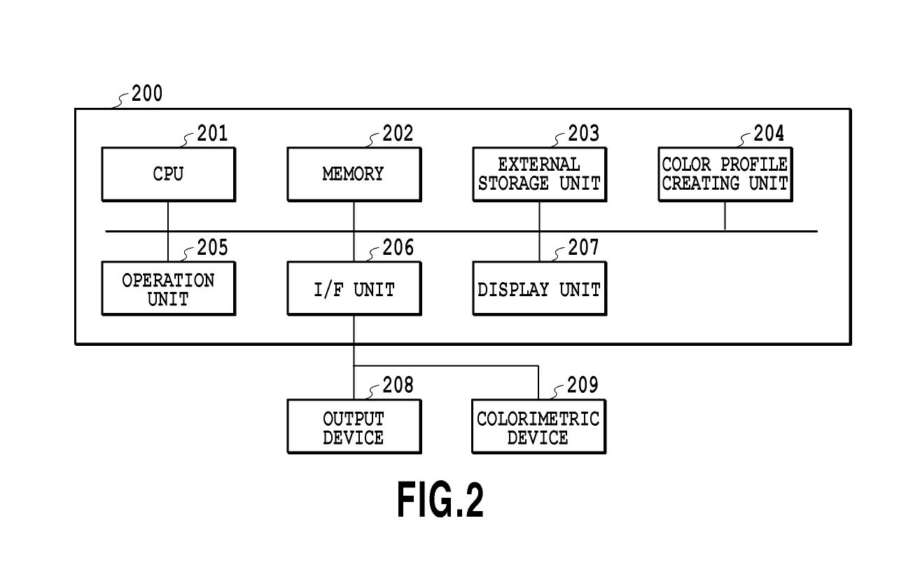

FIG. 2 is a block diagram illustrating a schematic configuration of an entire system of according to a first embodiment. A host computer 200 includes a CPU 201, a memory 202, an external storage unit 203, a color profile creating unit 204, an operation unit 205, an I/F unit 206, and a display unit 207. The CPU 201 executes parameter creation processing, which is described later, on an OS using data and a program stored in the memory 202 and the external storage unit 203. The program and the data are loaded on the memory 202 from the external storage unit 203 that is a hard disk or the like. The external storage unit 203 stores therein information necessary for the present invention. Details of the stored information are described later. The color profile creating unit 204 creates a parameter in accordance with the program executed by the CPU 201. The created parameter is stored in the external storage unit 203. Details of processing executed by the color profile creating unit 204 are described later.

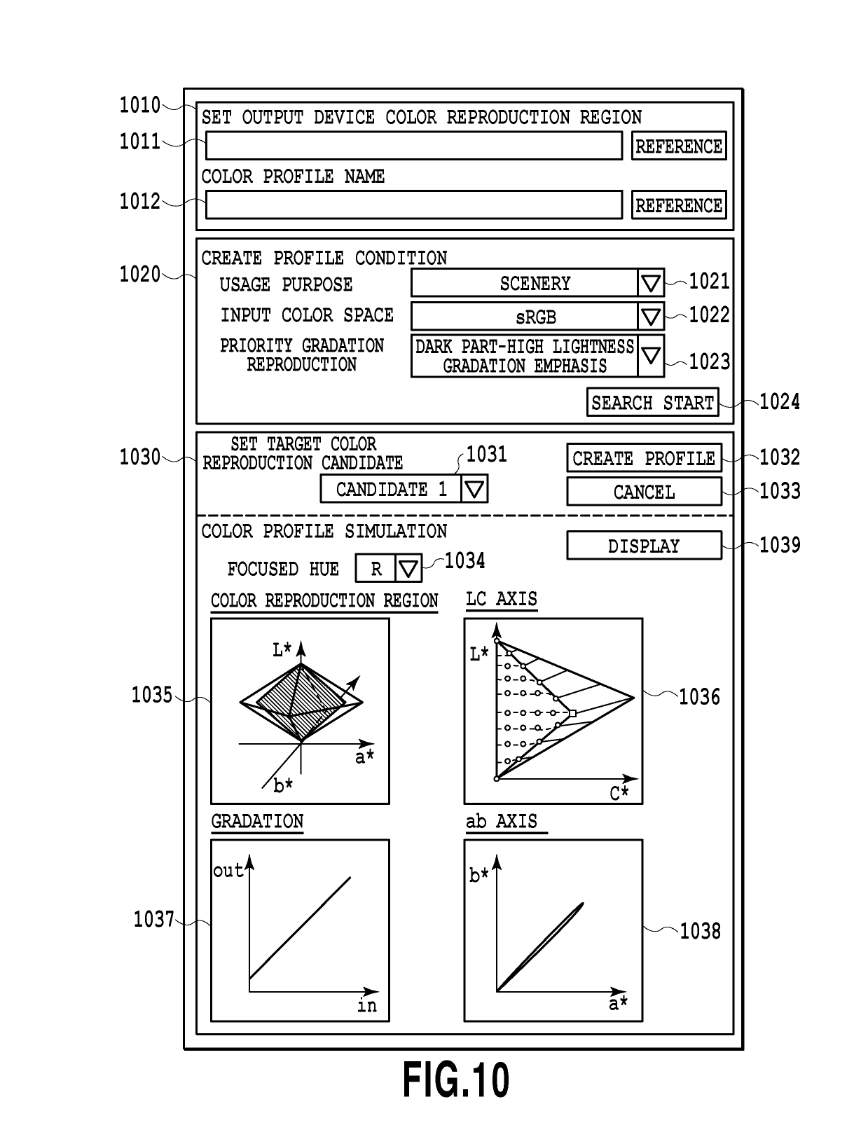

The host computer 200 is connected to an output device 208 and a colorimetric device 209 via the I/F unit 206. The output device 208 is, for example, an inkjet printer, a thermal transfer printer, a dot impact printer, or the like, and prints an image on paper based on image data created by the host computer 200 or the image data stored in the external storage unit 203. The colorimetric device 209 is, for example, a reflection spectrophotometer, such as Spectrolino, i1 Pro, or DTP41 manufactured by X-rite Inc., in the U.S.A. The colorimetric device 209 performs color measurement of a patch outputted by the output device 208, and transmits color measurement value data acquired by the patch color measurement to the host computer 200 via the I/F unit 206. The color measurement value data transmitted to the host computer 200 is stored in the external storage unit 203, and is used at subsequent parameter creation. In an example in FIG. 2, although the output device 208 and the colorimetric device 209 are respectively configured as individual devices, the configuration of an output device of a colorimetric device built-in type in which the output device 208 incorporates the colorimetric device 209 may be employed. The host computer 200 performs transmission/reception of various pieces of data relating to control of the output device 208 and the colorimetric device 209. The CPU 201 loads a program stored in the external storage unit 203 on the memory 202, and executes the program to execute processes in the present invention. The operation unit 205 is a component with which a user executes input, and is configured to include input I/F units such as a keyboard and a mouse. The display unit 207 is a component that displays an UI exemplified in FIG. 10 accordingly to display a setting screen for a profile creation condition, a processing progress, a processing result, and the like, and specifically, is a display unit, such as a display.

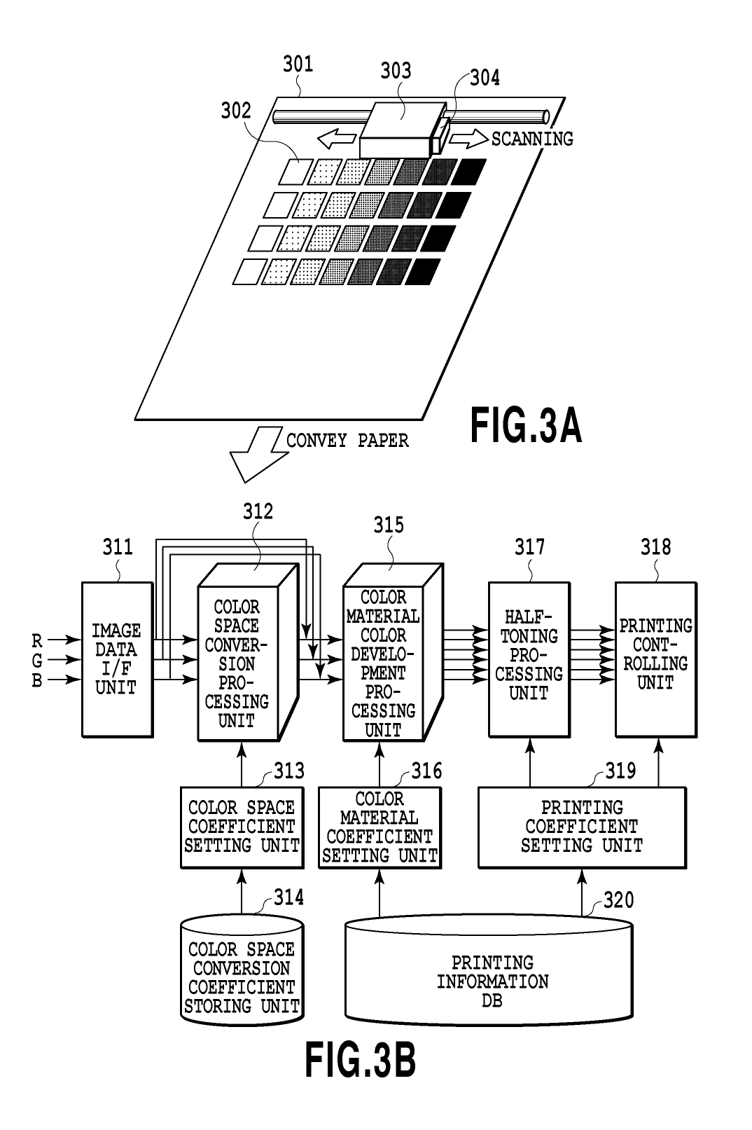

FIG. 3A and FIG. 3B are explanation views of the output device 208 according to the present embodiment. The output device 208 can perform an output using a color profile (details will be explained later) created in accordance with the present embodiment. Note that, a case where an inkjet printer is used as the output device 208 will be explained as an example in the following.

Firstly, with reference to FIG. 3A, a configuration and an operation of a discharge printing unit of the inkjet printer will be explained. A carriage 303 with a recording head that discharges ink being mounted thereon can move in the horizontal direction with respect to paper 301 in the drawing. This movement of the carriage 303 allows the recording head to scan the paper, and an image to be recorded. Patch images 302 illustrated in FIG. 3A can also be recorded similarly. Herein, it is assumed that the inkjet printer internally includes the colorimetric device 209. A sensor 304 is provided at a side of the carriage 303, and the sensor 304 constitutes a colorimetric device, which is described later, according to the embodiment. In other words, the carriage 303 is moved to allow the sensor 304 to detect the color of the formed patch image, and color measurement of the patch to be performed. The discharge printing unit can be implemented by a publicly known technique, and thus only a schematic configuration indicating a relation among the paper, the discharge head, and the carriage is explained herein, and a detailed explanation thereof is omitted. Note that, a portion of the inkjet printer in which the colorimetric device is internally included is not limited to that in this example.

Next, with reference to FIG. 3B, a configuration of the inkjet printer will be explained. The output device 208 includes an image data I/F unit 311, a color space conversion processing unit 312, a color material color development processing unit 315, a half-toning processing unit 317, and a printing controlling unit 318. Moreover, the output device 208 includes a color space coefficient setting unit 313, a color material coefficient setting unit 316, and a printing coefficient setting unit 319. In addition, the output device 208 includes a color space conversion coefficient storing unit 314 and a printing information DB 320.

The image data I/F unit 311 receives image data of an input color space to be printed. The color space conversion processing unit 312 subjects a publicly known three-dimensional look-up table (abbreviated as “3D-LUT” in this description) process to the image data of the input color space to convert the image data of the input color space into output device dependent RGB image data. The color space conversion coefficient storing unit 314 sends pieces of information such as a printing medium, a printing mode, and a printing purpose to the color space coefficient setting unit 313 as a parameter necessary for the process in the color space conversion processing unit 312, and the color space coefficient setting unit 313 sets a desired color profile. The color space conversion processing unit 312 executes a conversion process based on the set color profile. Further, the color space conversion processing unit 312 can also acquire a color profile that is created by the color profile creating unit 204 and stored in the external storage unit 203 in FIG. 2 via the I/F unit 206, and use it. In the 3D-LUT process executed by the color space conversion processing unit 312, a process using grid points configured by 16 stages or 32 stages for each color is normally executed. Herein, an example in which image data expressed in 8 bits for each of the RGB is processed using 4096 (=16×16×16) pieces of grid points configured by 16 grid points at an interval of every 17 grid points is explained.

The color material color development processing unit 315 receives output device dependent RGB image data outputted from the color space conversion processing unit 312. The color material color development processing unit 315 converts an output device dependent RGB signal into a signal for each color in accordance with the color material of the output device 208. This conversion is executed by the publicly known 3D-LUT process, and called as a color material color development process. The color material coefficient setting unit 316 sets a parameter necessary for the process in the color material color development processing unit 315, from the information stored in the printing information DB 320. The printing information DB 320 stores therein various kinds of parameters to be necessary in a case where the color material color development processing unit 315, the half-toning processing unit 317, the printing controlling unit 318 execute the processes. Although a detailed explanation for the various kinds of the parameters is omitted, the printing coefficient setting unit 319 manages various kinds of parameters in accordance with the type of media, the printing mode, the printing purpose, and the like, and selectively sets the parameters if necessary.

The half-toning processing unit 317 receives data developed on a color material. The half-toning processing unit 317 converts data developed on the color material into binary data using an error diffusion method, a dither method, or the like, and outputs the binary data. The printing controlling unit 318 having received the binary data outputted from the half-toning processing unit 317 performs printing control in accordance with the number of printing passes to execute printing.

Although the overview of an image output device that receives an RGB signal is explained in the forgoing, the present invention also can be implemented in an image output device that receives a CMYK signal similarly. Moreover, although an explanation is made in the present embodiment by assuming that all the components illustrated in FIG. 3B are included in the output device 208, these components may be disposed by being distributed in multiple devices.

### (Preparation of Color Reproduction Target Value Candidates)

In the present embodiment, by considering viewpoints explained below, multiple color reproduction target value candidates having various shapes of color reproduction regions and color adjustment being subjected thereto are previously prepared.

<(1) Dealing with Input Color Spaces (sRGB, AdobeRGB, and the Like)>

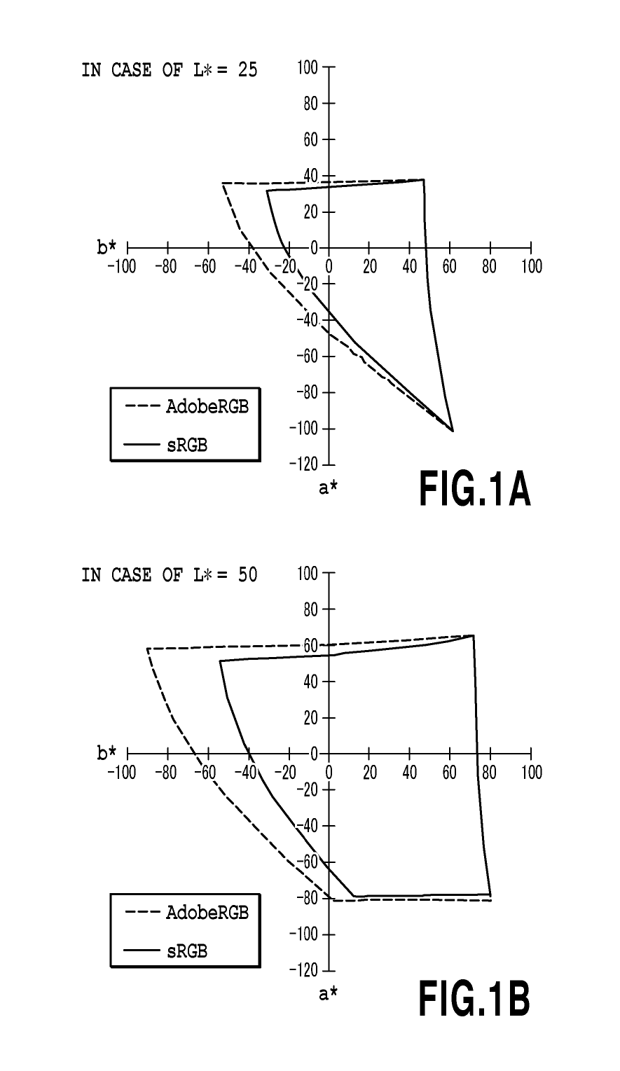

A color reproduction region of an output device and a color reproduction region of an input device are often different from each other in shapes (a lightness width and a color reproduction region). This raises a case where color reproduction of a color profile that uses all the color reproduction regions of the output device does not match an image checked on an input color space such as a monitor. For example, a color region of an inkjet printer often has a CG region (cyan-green region) wider than a sRGB color space widely used in a monitor. Thus, the chroma in the CG region in a case where a color profile that uses all the color reproduction regions of the output device is created to perform printing is higher than that in the monitor, whereby a printing matter with a worse color balance than the image quality that a user expected may be outputted. In recent years, color spaces having various color reproduction regions other than sRGB, such as AdobeRGB, as an input color space, are started to be used (see FIG. 1A and FIG. 1B). Accordingly, the input color space is also necessary to be considered in order to create a color profile.

<(2) Dealing with Color Reproducibility of Chromatic Color in Accordance with a Usage Purpose or a Scene>

A region to be used in the color reproduction region of the output device and the extent for color adjustment are different in accordance with a usage purpose of a user or a scene. For example, the color region of a high lightness region in an inkjet output is often wider than that in a silver salt output. Thus, a user who desires to output a printing matter in reproduction of soft colors similar to the silver salt output may not use the color region of the high lightness region of the inkjet printer. Moreover, a user who prints scenery needs dealing with memory colors from G to B that are colors often used for the scenery, such as a blue color or a green color of trees, and the wideness of the color reproduction region that allows the depth of the color to be rendered. Thus, hue adjustment for the colors from G to B by dealing with the memory colors and a color reproduction target value in which a dark part color reproduction region is appropriately expanded more than in the input color space in order to render the depth of the color are preferable. In addition, in a case where a poster is outputted, in order to provide the prominent image quality even from a distance, it is preferable to provide a color reproduction target value that allows a high chroma region in the color reproduction region of the output device to be completely used. Therefore, a color reproduction target value of various shapes to which the color adjustment is subjected in response to the usage purpose of the user or the scene is required.

<(3) Dealing with the Gradation Reproducibility in a Dark Part and a High Lightness Region and the Chroma Gradation Reproducibility of a Chromatic Color>

In order to satisfy the gradation reproducibility in the dark part and the high lightness region or the chroma gradation reproducibility of a chromatic color, a color reproduction target value of a shape close to the color reproduction region of the output device that performs printing needs to be selected by an instruction by a user.

For example, a user who prints an image of which subject is person, such as a wedding photograph, places importance on the gradation reproducibility in the dark part and the high lightness region in order to render dress and hair and reproduce a stereoscopic effect. However, in a case where a lightness difference from white to black in the color reproduction region of the output device is extremely narrower than that of a color reproduction target value, a color region compression process when a color profile is created makes the lightness be largely distorted. As a result, the intermediate lightness region is intended to be held to result in the distorted reproducibility in the dark part and the high lightness region, whereas the reproducibility in the dark part and the high lightness region is intended to be held to result in the soft gradation of a whole profile.

In contrast, in a case where a lightness difference from white to black in the color reproduction region of the output device is extremely wider than that of the color reproduction target value, the intermediate lightness region is intended to be held to result in an image in which the reproducibility in the dark part and the high lightness region is a hard gradation. Also, the reproducibility in the dark part and the high lightness region is intended to be held to result in the hard gradation of a whole profile and the image quality being wholly hard and having a discomfort feeling. Accordingly, also in this case, it is difficult to say that the image quality meets the desire by the user.

In addition, a user who prints a scenery image including a vivid-colored flower, a deep green-colored mountain, or the like, a poster, or the like, places importance on the gradation reproducibility in a high chroma region. However, in a case where the color reproduction range of the color reproduction region of the output device is very narrower than that of the color reproduction target value, the color region compression process when a color profile is created makes the color reproduction range be largely distorted. As a result, the internal color reproduction is intended to be held to result in the distorted gradation reproducibility in the high chroma region, whereas the gradation reproducibility in the high chroma region is intended to be held to result in reproduction of the lower internal chroma, so that the scenery image, the poster, or the like is printed in a faint color as a whole. This results in the wholly pale and faint image quality compared with the impression on the monitor. In contrast, in a case where the color reproduction range of the color reproduction region of the output device is very wider than that of the color reproduction target value, the color reproduction range of the output device cannot be effectively used.

### (Creation of Color Profile)

Next, a process of extracting a color reproduction target value out of multiple color reproduction target value candidates and creating a color profile according to the present embodiment will be explained.

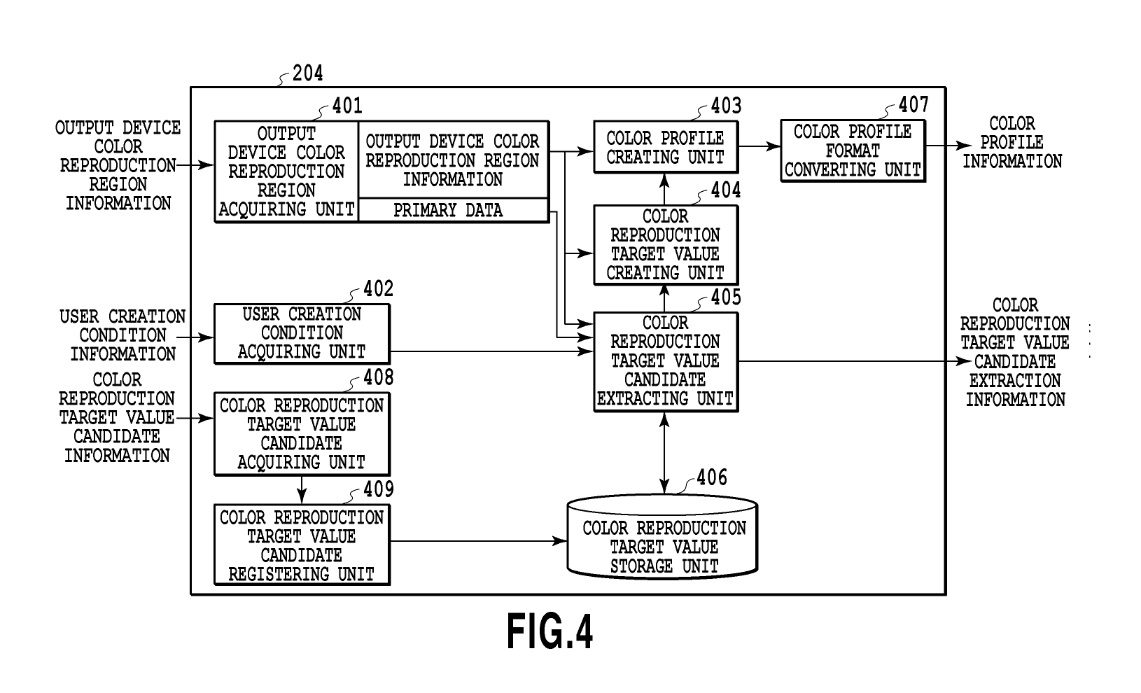

FIG. 4 is a block diagram illustrating a detailed configuration the color profile creating unit 204. The color profile creating unit 204 includes an output device color reproduction region acquiring unit 401, a color profile creating unit 403, a color reproduction target value creating unit 404, a color reproduction target value candidate extracting unit 405, and a color profile format converting unit 407. Moreover, the color profile creating unit 204 includes a user creation condition acquiring unit 402, a color reproduction target value storage unit 406, a color reproduction target value candidate acquiring unit 408, and a color reproduction target value candidate registering unit 409.

Input information to the color profile creating unit 204 includes output device color reproduction region information and user creation condition information that are designated by a user, and color reproduction target value candidate information. The color reproduction target value candidate information is configured to include data newly registered in the color reproduction target value storage unit 406.

Output information from the color profile creating unit 204 includes color profile information created by the color profile creating unit 204, and color reproduction target value candidate extraction information indicating whether a suitable color reproduction target value candidate is present and creation of a color profile is possible.

The output device color reproduction region information is acquired by color measurement to a patch printed by the output device that previously creates a color profile. The output device color reproduction region information is configured by patch color measurement value data in which output device dependent RGB values and color measurement values (Lab) are in association with each other, and is stored in the external storage unit 203. The output device color reproduction region acquiring unit 401 acquires output device color reproduction region information designated by through a UI in FIG. 10, which is described later, and creates primary data in which eight pieces of information on R, G, B, C, M, and Y, and black and white are extracted. Specifically, the primary data is configured by CIEL*a*b*values in R: (255,0,0), G: (0,255,0), B: (0,0,255), C: (0,255,255), M: (255,0,255), Y: (255,255,0), W: (255,255,255), and Bk: (0,0,0) in a case where RGB values are respectively 8-bit data. The output device color reproduction region information configured by patch color measurement value data is sent to the color profile creating unit 403, the color reproduction target value creating unit 404, and the color reproduction target value candidate extracting unit 405. The primary data is sent to the color reproduction target value candidate extracting unit 405.

The user creation condition information is information including data of conditions set by the user on the UI in FIG. 10 displayed in the display unit 207. The user creation condition acquiring unit 402 acquires user creation condition information, and sends the user creation condition information to the color reproduction target value candidate extracting unit 405. The color reproduction target value candidate extracting unit 405 then extracts, out of color reproduction target value candidates stored in the color reproduction target value storage unit 406, a color reproduction target value candidate that matches the user creation condition. Herein, primary data that corresponds to respective input color spaces designated through an input color space setting field 1022 in FIG. 10, which is described later and corresponds to color reproduction target value candidates constituting various color reproduction region is stored in the color reproduction target value storage unit 406 in advance. A color reproduction target value is configured by CIEL*a*b*values corresponding to grid points used in the 3D-LUT process executed by the color space conversion processing unit 312 in FIG. 3B. The more the number of color reproduction target value candidates stored in the color reproduction target value storage unit 406 is, the more desired image quality the user can select, thereby obtaining a high effect by the present invention. The primary data of the color reproduction target value candidates in the present embodiment is L*a*b*values in R: (255,0,0), G: (0,255,0), B: (0,0,255), C: (0,255,255), M: (255,0,255), Y: (255,255,0), W: (255,255,255), Bk: (0,0,0), in a case where RGB values are respectively 8-bit data. Moreover, the color reproduction target value candidate is based on color profile information having high perfection and created by repeating printing, color measurement, subjective evaluation, and color profile correction by conventional methods. The color reproduction target value creating unit 404 creates a desired color reproduction target value (a method of creating a color reproduction target value is described later), from the color reproduction target value candidate extracted by the color reproduction target value candidate extracting unit 405. The color profile creating unit 403 creates a color profile based on the created color reproduction target value. Thereafter, the color profile format converting unit 407 converts the created color profile into a format thereof capable of being stored in the color space conversion coefficient storing unit 314, and outputs the color profile after the conversion as a result by the color profile creating unit 204.

The color reproduction target value candidate information inputted into the color profile creating unit 204 is configured by candidate data newly registered in the color reproduction target value storage unit 406. The registration process is a process utilized in a case where color reproduction target value candidate extraction information indicating error information is sent from the color reproduction target value candidate extracting unit 405 that has failed to extract a color reproduction target value candidate because no desired color reproduction target value candidate is present. The registration process is utilized for adding a color profile created by a different method or externally acquired as a color reproduction target value candidate. The color reproduction target value candidate acquiring unit 408 acquires a color reproduction target value candidate expected to be newly added as color reproduction target value candidate information, and the color reproduction target value candidate registering unit 409 registers the color reproduction target value candidate.

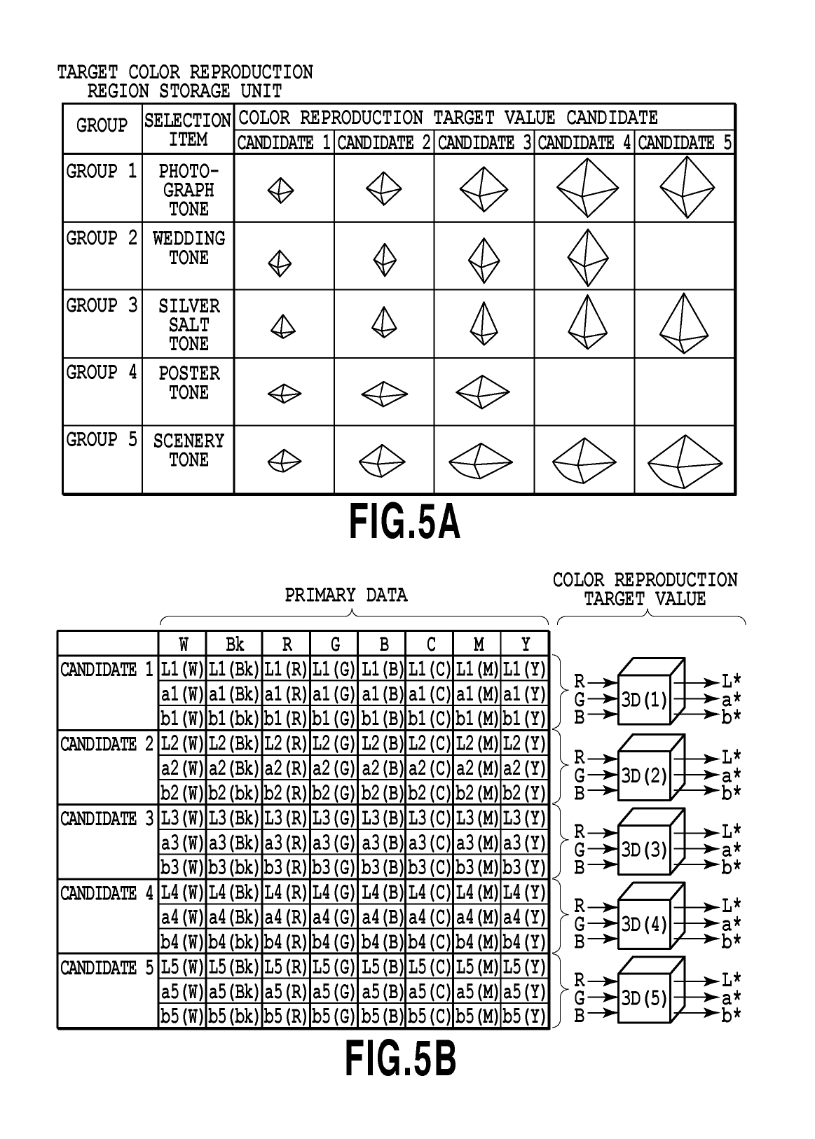

FIG. 5A and FIG. 5B are views explaining color reproduction target value candidates stored in the color reproduction target value storage unit 406. FIG. 5A illustrates a situation in which color reproduction target value candidates are classified for each selection item in a usage purpose setting field 1021 in FIG. 10, and are stored in the color reproduction target value storage unit 406. Moreover, FIG. 5B illustrates a situation in which color reproduction target value candidates 1 to 5 for a group 5 (selection item: scenery tone) in FIG. 5A are stored in the color reproduction target value storage unit 406. Herein, groups 1 to 5 in FIG. 5A respectively correspond to selection items capable of being set through the usage purpose setting field 1021 on the UI in FIG. 10, which is described later. In the present embodiment, an explanation is made by assuming that the user can selectively set a usage purpose from the five groups below through the usage purpose setting field 1021. The color reproduction target value storage unit 406 stores therein color reproduction target value candidates in association with the respective groups. Each of the groups is designed so as to achieve color reproduction in accordance with a usage purpose or a scene. Characteristics of the respective groups according to the present embodiment are as follows.

Group 1 Photograph tone: The photograph tone is a color reproduction target value that takes advantage of color regions of the inkjet printer as the output device in the present embodiment, and copes with a general-purpose photograph.

Group 2 Wedding tone: The wedding tone is a color reproduction target value that places more importance on the reproducibility in the dark part and the high lightness region than the color reproduction, and holds the lightness in the gradation in the dark part and the high lightness region compared with the photograph tone.

Group 3 Silver salt tone: The silver salt tone is a color reproduction target value that uses the reduced color region at the high lightness side, has a high reproducibility at the high chroma side, and provides a soft impression, and has a color reproduction region in the high lightness region narrower than that in the photograph tone and a good color discrimination property in the high chroma region.

Group 4 Poster tone: The poster tone is a color reproduction target value that takes advantage of the color reproduction region of the output device so as to be prominent even from a distance and provides a vivid impression in the high chroma region compared with in the input color space, and has a color reproduction region wider than that in the photograph tone.

Group 5 Scenery tone: The scenery tone is a color reproduction target value that places importance on the memory colors of the color often used for the scenery, such as a blue color of sky or a green color of trees and the color discrimination property, and has a high reproducibility in the dark part and the high lightness region, and is designed so as to have a color reproduction region from G to C of low lightness wider than that in the photograph tone and to have no distorted chroma gradation.

As described above, FIG. 5B illustrates a situation where color reproduction target value candidates 1 to 5 for the group 5 (selection item: scenery tone) in FIG. 5A are stored. The color reproduction target value candidates stored for each group satisfies color reproduction corresponding to a usage purpose of the group. Moreover, various candidates are stored for each group in order to cope with shapes of the input color space and the color reproduction region of the output device. For example, the candidates in the same group have different lightness widths from white to black and different sizes of the color reproduction region in the chroma direction, and are designed so as to prevent the lightness gradation and the chroma gradation from being distorted even for various color reproduction regions of output devices. The color reproduction target value storage unit 406 holds, as the color reproduction target value candidates 1 to 5, five types of primary data, and a color reproduction target value corresponding to each primary data by being associated with each other. For convenience in writing, L*a*b*values that constitute primary data of a candidate x (wherein, x is any one of from 1 to 5) are represented as Lx(Y), ax(Y), bx (Y) (wherein, Y is any one of W, Bk, R, G, B, C, M, and Y). Moreover, L*a*b*values that are target values relative to input values of the grid points used in the 3D-LUT process executed by the color space conversion processing unit 312 are expressed as 3D(x). In the present embodiment, the L*a*b*values as a color reproduction target value are associated with 4096 (=16×16×16) pieces of grid points in an RGB color space being expressed in 8 bits for each of the RGB and configured by 16 grid points at an interval of every 17 grid points.

Note that, in the present embodiment, although a case where five groups are stored in the color reproduction target value storage unit 406 is explained as an example, an addition group may be added or the number of the groups may be reduced. Moreover, the number of candidates stored in one group may be one or more, and the number is not limited.

Thus, the color reproduction target value candidate registering unit 409 newly adds a group of color reproduction target value candidates if necessary in accordance with an instruction included in the color reproduction target value candidate information. Specifically, the color reproduction target value candidate registering unit 409 registers a color reproduction target value candidate corresponding to a group to be added. Moreover, the color reproduction target value candidate registering unit 409 creates primary data for the color reproduction target value candidate to be added, and stores the primary data in the color reproduction target value storage unit 406. This process allows a color profile to be created with respect to an output device having a color reproduction region incapable of being coped with. Further, a color reproduction target value candidate capable of being registered may be a favorite color profile out of color profiles created by the same color profile creation apparatus. Moreover, a color reproduction target value candidate capable of being registered may be acquired by printing and color measurement of a predetermined patch in an output device that the user can perform printing with a favorite image quality, and is not limited to the color reproduction target value candidate created by the abovementioned method.

### (Flow of Color Profile Creation Processing)

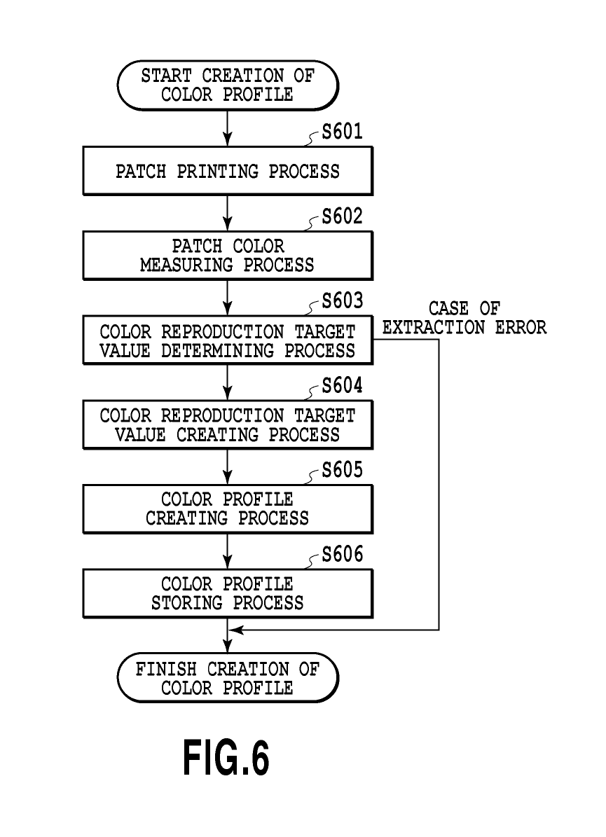

Color profile creation processing according to the present invention will be explained with reference to a flowchart in FIG. 6. The CPU 201 executes a program, and controls the respective components in accordance with the program to execute the processing. Moreover, color reproduction target value candidate information, output device color reproduction region information, and user creation condition information that are used in the processing are stored in the external storage unit 203.

### <S601>

At step S601, the output device 208 prints a patch chart for color measurement of printing color reproduction relative to output device dependent RGB. A color patch unit of the patch chart is configured by patches of which number is the same as the number of grid points (4096 pieces) that is used by the color space conversion processing unit 312 in FIG. 3B. Note that, in the present embodiment, although a case where the number of patches is the same as the number of grid points used by the color space conversion processing unit 312 is explained as an example, a patch chart having the number of patches less than the number of grid points, such as 729 (=9×9×9) pieces, may be used.

The output device 208 is controlled in accordance with a printing software program executed in the host computer 200. When the host computer 200 receives an instruction to start patch chart printing via the operation unit 205, the CPU 201 reads patch chart image data stored in the external storage unit 203 in advance, and transfers the patch chart image data to the output device 208 via the I/F unit 206. The output device 208 prints the patch chart in accordance with the transferred patch chart image data. The patch chart printing processing is not executed in the color space conversion processing unit 312 but executed in the color material color development processing unit 315, the half-toning processing unit 317, and the printing controlling unit 318, thereby executing output based on the output device dependent RGB values.

### <S602>

At step S602, the colorimetric device 209 performs color measurement of the patch unit of the patch chart printed at step S601, and creates output device color reproduction region information. The colorimetric device 209 is controlled in accordance with a color measurement software program executed in the host computer 200. Color measurement value data acquired by measurement performed by the colorimetric device 209 is stored in the external storage unit 203 via the I/F unit 206. The color measurement value data stored in the external storage unit 203 includes, specifically, RGB values corresponding to the patch unit, and L*a*b*values associated with the RGB values and acquired by the color measurement.

### <S603>

At step S603, the color profile creating unit 204 determines a color reproduction target value. Specifically, the output device color reproduction region acquiring unit 401 acquires the output device color reproduction region information created at step S602, and the user creation condition acquiring unit 402 acquires user creation condition information set using the UI in FIG. 10, which is described later. Further, based on these acquired two pieces of the information, the color reproduction target value candidate extracting unit 405 extracts color reproduction target value candidates (for example, candidate 1 to candidate 5 in FIG. 5A and FIG. 5B) that match a condition, out of multiple color reproduction target value candidates stored in the color reproduction target value storage unit 406. Further, the extracted candidates are presented to a user on the UI, and the user is prompted to select a candidate that matches the request, thereby determining a color reproduction target value. Further, in a case where no matching candidate is present, an error display indicating that no matching candidate is present is presented to the user on the UI. In this manner, the process at step S603 is executed by the user creation condition acquiring unit 402 and the color reproduction target value candidate extracting unit 405 in FIG. 4. Details of the process at step S603 will be explained later with reference to FIG. 9A-1 to FIG. 9C.

### <S604>

At step S604, the color reproduction target value creating unit 404 calculates a target value in each of the grid points necessary for creating a color profile based on the color measurement value data acquired at step S602 and the color reproduction target value determined at step S603.

For convenience explanation of the process, the L*a*b*values acquired by the color measurement at step S602 is expressed as Lᵢₙ(R, G, B), aᵢₙ(R, G, B), and bᵢₙ(R, G, B) relative to count values RGB of the patch, respectively. Moreover, the color reproduction target value of the candidate determined at the previous process step S603 is expressed as L_{ref}(R,G,B), a_{ref}(R,G,B), and b_{ref}(R,G,B). The color reproduction target value calculated at the process step S604 is expressed as Lₒᵤₜ(R, G, B) aₒᵤₜ(R,G,B), and bₒᵤₜ(R, G, B). The respective values of RGB herein are values at the grid points, and thus the value is any one of 0, 17, 34, 51, 68, . . . , and 255.

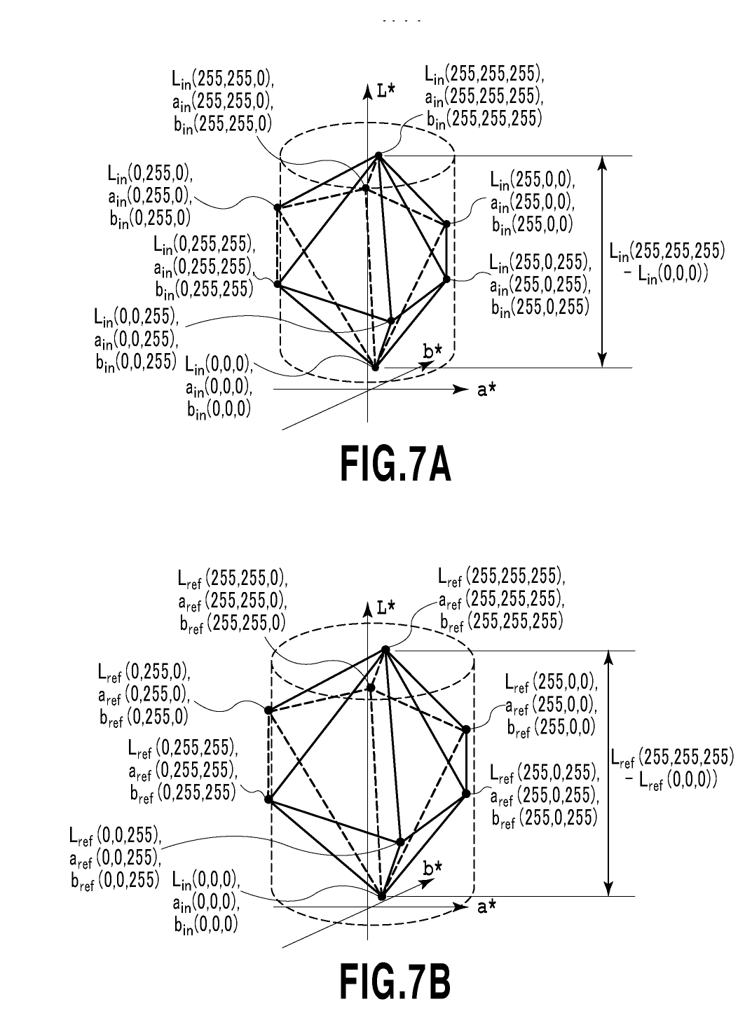

FIG. 7A and FIG. 7B are graphs indicating L*a*b*values of W, Bk, R, G, B, C, M, and Y in an L*a*b* coordinates system. FIG. 7A illustrates the patch color measurement value acquired by patch color measurement at step S602, and FIG. 7B illustrates the color reproduction target value of the candidate determined at step S603. In the present embodiment, these values are used to determine a compression/expansion rate α in an L* direction with W and Bk and a compression/expansion rate β on an a*b* plane with R, G, B, C, M, and Y, thereby calculating a target value in each of the grid points. In the present embodiment, the compression/expansion rate α in the L* direction is obtained by an expression (1).

α={Lᵢₙ(255,255,255)−Lᵢₙ(0,0,0)}/{L_{ref}(255,255,255)−L_{ref}(0,0,0)} Expression (1)

Further, a target value Lₒᵤₜ(R,G,B) of each of the grid points calculated in the process is calculated by an expression (2).

Lₒᵤₜ(R,B)=Lᵢₙ(0,0,0)+αx{L_{ref}(R,G,B)−L_{ref}(0,0,0)} Expression (2)

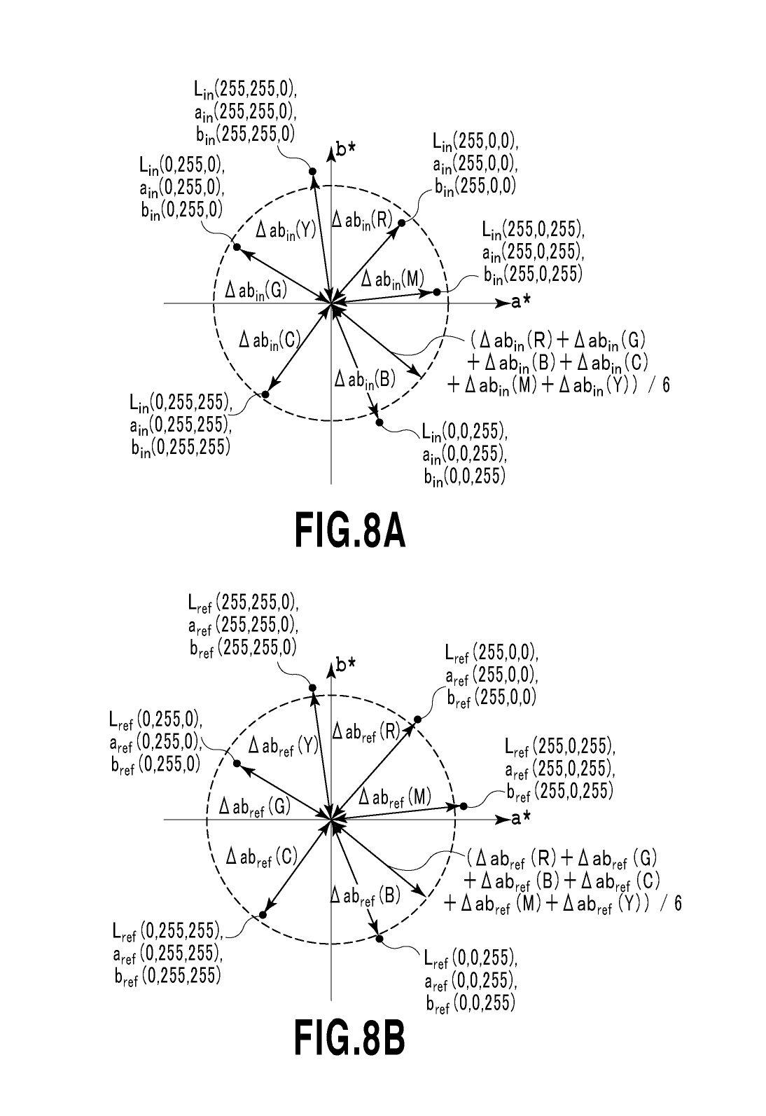

Next, the compression/expansion rate β on the a*b* plane is determined based on the L*a*b*values of R, G, B, C, M, and Y. FIG. 8A and FIG. 8B are graphs illustrating a*b*values of R, G, B, C, M, and Y in a*b* coordinates system. FIG. 8A illustrates the patch color measurement value acquired by patch color measurement at step S602, and FIG. 8B illustrates the color reproduction target value of the candidate determined at step S603. In the present embodiment, an attention is paid to the a*b* coordinates being polar coordinates, and the compression/expansion rate β as the rate of a patch color measurement value relative to a color reproduction target value of the candidate about a mean value of vector distances from the L axis of each color, is calculated by an expression (3). Further, a target value in each of the grid points of a recording medium subjected to the color measurement is calculated by an expression (4) and an expression (5) based on the compression/expansion rate β. Herein, a distance from the L axis of each color is expressed as Δab(n) for a color of n, a color-measured patch is expressed as Δabᵢₙ(n), and a color reproduction target value of the determined candidate is expressed as Δab_{ref}(n). Moreover, a distance of the color reproduction target value of the determined candidate to (R,G,B) grid points is expressed as Δab_{ref}(R,G,B). Note that, Δabᵢₙ(n) and Δab_{ref}(n) in the explanation are obtained from an addition mean value, but may be obtained by a root mean square. A distance from the L axis of each color of the color-measured patch is as follows.

Δabᵢₙ(R)=SQR(aᵢₙ(255,0,0)²+bᵢₙ(255,0,0)²)

Δabᵢₙ(G)=SQR(aᵢₙ(0,255,0)²+bᵢₙ(0,255,0)²)

Δabᵢₙ(B)=SQR(aᵢₙ(0,0,255)²+bᵢₙ(0,0,255)²)

Δabᵢₙ(C)=SQR(aᵢₙ(0,255,255)²+bᵢₙ(0,255,255)²)

Δabᵢₙ(M)=SQR(aᵢₙ(255,0,255)²+bᵢₙ(255,0,255)²)

Δabᵢₙ(Y)=SQR(aᵢₙ(255,255,0)²+bᵢₙ(255,255,0)²)

A distance from the L axis of each color of the color reproduction target value of the determined candidate is as follows.

Δab_{ref}(R)=SQR(a_{ref}(255,0,0)²+b_{ref}(255,0,0)²)

Δab_{ref}(G)=SQR(a_{ref}(0,255,0)²+b_{ref}(0,255,0)²)

Δab_{ref}(B)=SQR(a_{ref}(0,0,255)²+b_{ref}(0,0,255)²)

Δab_{ref}(C)=SQR(a_{ref}(0,255,255)²+b_{ref}(0,255,255)²)

Δab_{ref}(m)=SQR(a_{ref}(255,0,255)²+b_{ref}(255,0,255)²)

Δab_{ref}(Y)=SQR(a_{ref}(255,255,0)²+b_{ref}(255,255,0)²)

In this case, the compression/expansion rate β is obtained by the expression (3).

β={Δabᵢₙ(R)+Δabᵢₙ(G)+Δabᵢₙ(B)+Δabᵢₙ(C)+Δabᵢₙ(M)+Δabᵢₙ(Y)}/{Δab_{ref}(R)+Δab_{ref}(G)+Δab_{ref}(B)+Δab_{ref}(C)+Δab_{ref}(M)+Δab_{ref}(Y)} Expression (3)

In this case, target value aₒᵤₜ(R,G,B) and bₒᵤₜ(R,G,B) of each of the grid points are obtained using the compression/expansion rate β by the expression (4) and the expression (5), in which θ(R,G,B)=tan⁻¹((a_{ref}(R, G, B)/b_{ref}(R, G, B)).

aₒᵤₜ(R,G,B)=Δab_{ref}(R,G,B)×β×Cos(θ(R,G,B)) Expression (4)

bₒᵤₜ(R,G,B)=Δab_{ref}(R,G,B)×β×Sin(θ(R,G,B)) Expression (5)

As described above, the L*a*b*values as a target value in each of the grid points are calculated by the expression (2), the expression (4), and the expression (5). Note that, although the abovementioned method is recommended as a color reproduction target value creation method, a color reproduction target value creation method according to the present invention is not limited to the abovementioned method.

### <S605>

At step S605, the host computer 200 creates a color profile. Specifically, the color profile creating unit 403 calculates, based on the target values (L*a*b*values) of the grid points calculated at step S604 and color measurement values of all the patches acquired at step S602, RGB values corresponding to the target value using a publicly known color region compression process. The color profile created in this step is transmitted to the color profile format converting unit 407. Lᵢₙ(R,G,B), aᵢₙ(R,G,B), and bᵢₙ(R,G,B) of the patch color measurement value are different from Lₒᵤₜ(R,G,B), aₒᵤₜ(R,G,B), and bₒᵤₜ(R,G,B) of the color reproduction target value. In this step, based on these pieces of information, calculated are RGB values corresponding to the patch color measurement value reproducing the same value as or the closest value to the color reproduction target value of Lₒᵤₜ(R,G,B), aₒᵤₜ(R,G,B), and bₒᵤₜ(R,G,B) relative to RGB values of the grid point used in a case where the color space conversion processing unit 312 performs the processing in FIG. 3B. A method of calculating the RGB values can be implemented by a calculation method according to the related art, such as reverse interpolate processing based on the two types of information described above because the L*a*b*values are associated with the RGB values.

### <S606>

At step S606, the output device 208 stores the color profile created and transmitted from the host computer 200 at step S605 in the color space conversion coefficient storing unit 314. The color profile is used for converting sRGB data in an input color space into output device (printer) dependent RGB data. The color profile format converting unit 407 converts the color profile created by the color profile creating unit 403 into the color profile of a format capable of being stored in the color space conversion coefficient storing unit 314. The color profile after the conversion is outputted as a result by the color profile creating unit 204. In this case, a name of the color profile is outputted as a name set through a color profile name setting field 1012 in FIG. 10.

### (Flow of Color Reproduction Target Value Determination Processing)

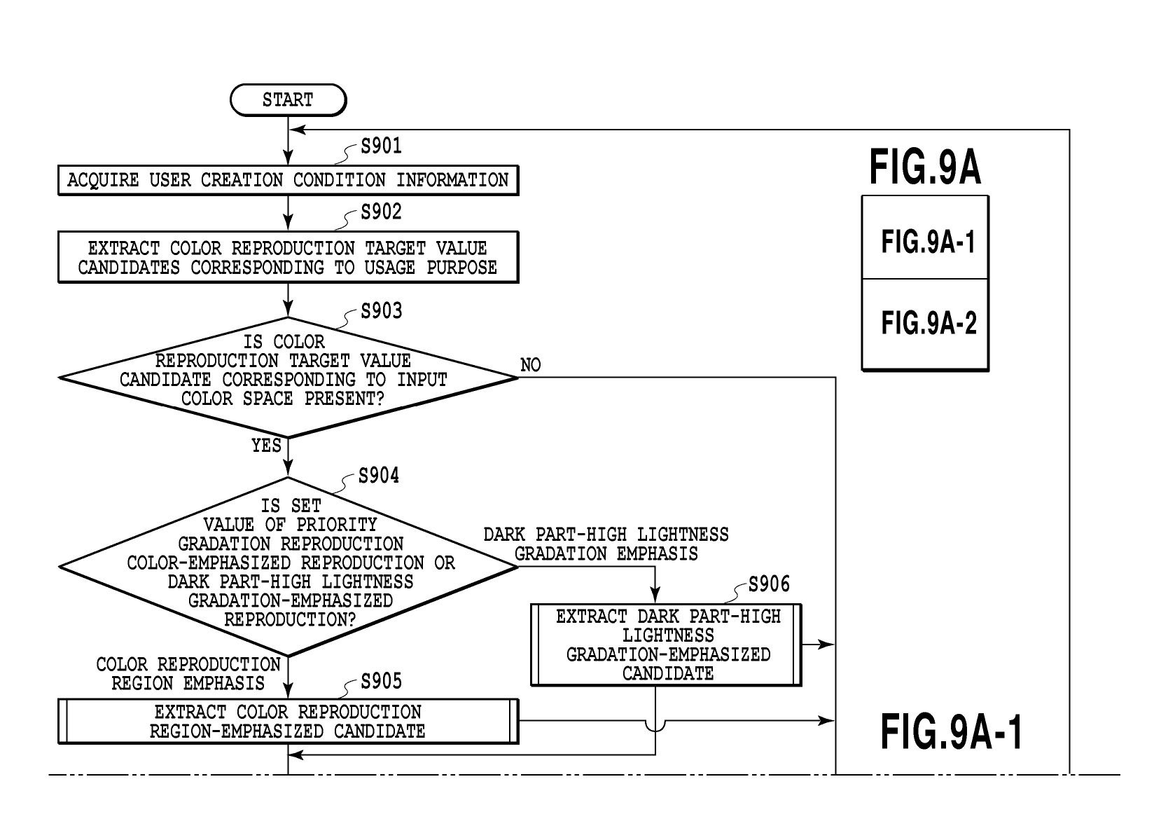

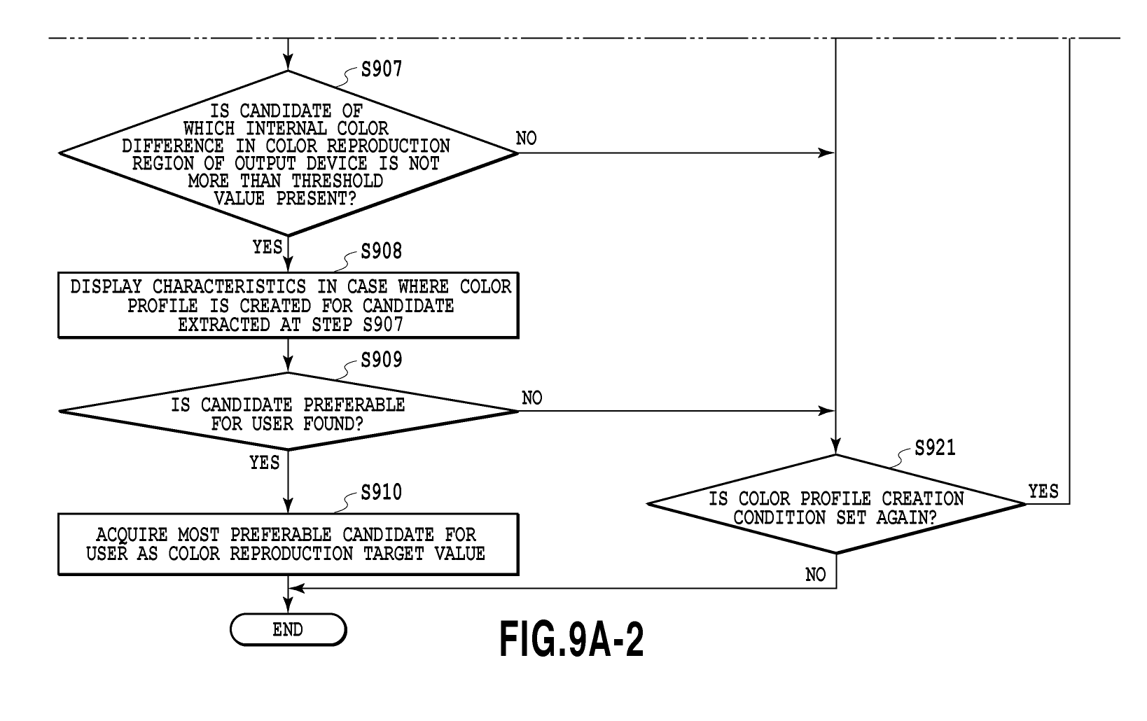

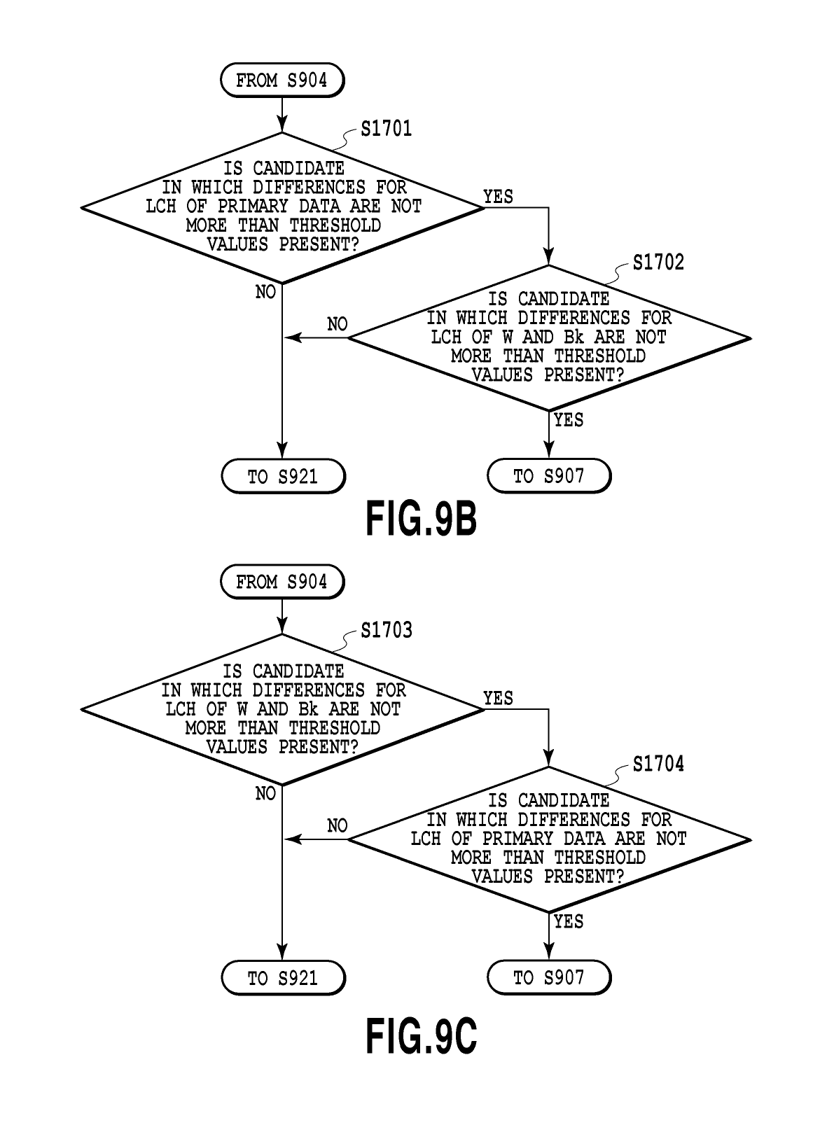

Here, determination processing of a color reproduction target value performed at step S603 will be explained with reference to a flowchart in FIG. 9A-1. In the processing, it is determined whether a color difference between primary data for the candidate stored in the color reproduction target value storage unit 406 and primary data for the color measurement values (L*a*b*values) in the color reproduction region of the output device acquired at step S602 is not more than a predetermined threshold value. Based on the determination, a color reproduction target value is selectively determined. Further, the abovementioned threshold value is set based on user creation condition information acquired in the following description.

### <S901>

At step S901, the user creation condition acquiring unit 402 acquires user creation condition information used in color profile creation. The user creation condition information is set by a user using the UI in FIG. 10, which is described later. The user creation condition information is specified by five items of an output device color reproduction region, a color profile name, a usage purpose (see FIG. 5A), an input color space (sRGB, AdobeRGB), and priority gradation reproduction (dark part-high lightness gradation-emphasized reproduction, chroma gradation-emphasized reproduction). When the user presses a search start button 1024 after having set these five items using the UI in FIG. 10, user creation condition information is sent to the color profile creating unit 204, and the user creation condition acquiring unit 402 acquires the user creation condition information.

### <S902>

At step S902, the color reproduction target value candidate extracting unit 405 extracts color reproduction target value candidates corresponding to the usage purpose in the user creation condition information acquired at step S901, from the color reproduction target value storage unit 406. The color reproduction target value candidates are stored in the color reproduction target value storage unit 406 by being categorized so as to correspond to the selection items in the usage purpose setting field 1021, as illustrated in FIG. 5B. Accordingly, the color reproduction target value candidate extracting unit 405 can extract color reproduction target value candidates corresponding to the usage purpose selected by the user using the usage purpose setting field 1021.

### <S903>

At step S903, the color reproduction target value candidate extracting unit 405 acquires the input color space in the user creation condition information acquired at step S901, and extracts a color reproduction target value candidate corresponding to the input color space, out of the color reproduction target value candidates extracted at step S902. In the present embodiment, in order to extract a color reproduction target value candidate suitable for the input color space, an attention is paid to the chroma of G and C in the a*b* region with a characteristic difference between the two input color spaces and at a predetermined lightness as illustrated in FIG. 1A and FIG. 1B. As specifically explained, in the present embodiment, in order to extract a color reproduction target value candidate, chroma C(L×M), C(L×G), and C(L×C) of M, G, and C at a predetermined lightness Lx are acquired, and chroma ratios compC(G/M) and compC(C/M) are calculated by an expression (6) and an expression (7).

compC(G/M)=C(L×G)/C(L×M) Expression (6)

compC(C/M)=C(L×C)/C(L×M) Expression(7)

Further, the color reproduction target value candidate extracting unit 405 extracts a color reproduction target value candidate with the calculated chroma ratio that falls within a predetermined threshold value range relative to the chroma ratio of theoretical values in each of the input color spaces as indicated in expressions (8) to (11).

sRGBTh1(G/M)≦compC(G/M)≦sRGBTh2(G/M) Expression (8)

sRGBTh1(C/M)≦compC(C/M)≦sRGBTh2(C/M) Expression (9)

AdobeRGBTh1(G/M)≦compC(G/M)≦AdobeRGBTh2(G/M) Expression (10)

AdobeRGBTh1(C/M)≦compC(C/M)≦AdobeRGBTh2(C/M) Expression (11)

At step S903, in a case where the color reproduction target value candidate with the chroma ratio that falls within the predetermined threshold value range is extracted, the processing proceeds to step S904, whereas in a case where no color reproduction target value candidate with the chroma ratio that falls within the predetermined threshold value range is extracted, the processing proceeds to step S921.

Note that, in the present embodiment, a case where an input color space is selected from two input color spaces of sRGB and AdobeRGB as an example, so that a candidate is extracted by paying an attention to the vicinity of CG where the difference between the two color reproduction regions is apparent. However, a method of extracting a candidate is not limited the above method, but a candidate may be extracted by paying an attention to other characteristics. Moreover, the items for the input color space selected by the user are not limited to sRGB and AdobeRGB, but the user may select another input color space. In a case where the number of selection items for the input color space is large, the selection items may be categorized in advance for every input color space at step S903 and the input color space may be extracted, in a similar manner as step S902.

### <S904>

At step S904, the color reproduction target value candidate extracting unit 405 acquires the priority gradation reproduction in the user creation condition information acquired at step S901, and determines whether a set value of the acquired priority gradation reproduction is color-emphasized reproduction or dark part-high lightness gradation-emphasized reproduction. As a result of determination, in a case where the set value of the acquired priority gradation reproduction is the color-emphasized reproduction, the processing proceeds to step S905, whereas in a case where the set value of the acquired priority gradation reproduction is the dark part-high lightness gradation-emphasized reproduction, the processing proceeds to step S906.

### <S905>

At step S905, the color reproduction target value candidate extracting unit 405 extracts a color reproduction target value candidate for chroma gradation-emphasized reproduction. Here, processing performed at step S905 will be explained with reference to a flowchart FIG. 9B.

### <S1701>

At step S1701, the color reproduction target value candidate extracting unit 405 calculates lightness, chroma, and a hue angle (hereinafter, referred to as LCH) from the color reproduction region of the output device, and L*a*b*values corresponding to R, G, B, C, M, and Y of the candidate extracted at step S902 by a publicly known method. The color reproduction target value candidate extracting unit 405 subsequently determines whether a candidate in which differences for the LCH of each of the colors are not more than threshold values set for the color-emphasized reproduction is present, and extracts the candidate in a case of being present. Hereinafter, the process is specifically explained.

Differences for the lightness of the respective colors are sequentially expressed as ΔLR, ΔLG, ΔLB, ΔLC, ΔLM, and ΔLY. Similarly, differences for the chroma of the respective colors are sequentially expressed as ΔCR, ΔCG, ΔCB, ΔCC, ΔCM, and ΔCY, and differences for the hue angles of the respective colors are sequentially expressed as ΔHR, ΔHG, ΔHB, ΔHC, ΔHM, and ΔHY. Moreover, previously set threshold values for the lightness of the respective colors are expressed as RLth, GLth, BLth, CLth, MLth, and YLth. Similarly, threshold values for the chroma of the respective colors are expressed as RCth, GCth, BCth, CCth, MCth, and YCth, and threshold values for the hue angles of the respective colors are expressed as RHth, GHth, BHth, CHth, MHth, and YHth. In this case, whether a suitable candidate is present is determined using expressions (12) to (14).

((ΔLR≦RLth)&(ΔLG≦GLth)&(ΔLB≦BLth)&(ΔLC≦CLth)&(ΔLM≦MLth)&(ΔLY≦YLth)) Expression (12)

((ΔCR≦RCth)&(ΔCG≦GCth)&(ΔCB≦BCth)&(ΔCC≦CCth)&(ΔCM≦MCth)&(ΔCY≦YCth)) Expression (13)

((ΔHR≦RHth)&(ΔHG≦GHth)&(ΔHB≦BHth)&(ΔHC≦CHth)&(ΔHM≦MHth)&(ΔHY≦YHth)) Expression (14)

In a case where all the expressions (12) to (14) are satisfied, it is determined that a suitable candidate is present, the color reproduction target value candidate is extracted, and the processing proceeds to step S1702. Whereas, in a case where at least one of the expressions (12) to (14) is not satisfied, it is determined that no suitable candidate is present, and the processing proceeds to step S921.

### <S1702>

At step S1702, the color reproduction target value candidate extracting unit 405 calculates lightness, chroma, and a hue angle (hereinafter, referred to as LCH) based on the color reproduction region of the output device, and L*a*b*values corresponding to W and Bk of the candidate extracted at step S1701 by a publicly known method. The color reproduction target value candidate extracting unit 405 subsequently determines whether a candidate in which differences for the LCH of each of the colors are not more than threshold values set for the color-emphasized reproduction is present, and extracts the candidate in a case of being present.

In other words, differences for the lightness of the respective colors are expressed as ΔLW and ΔLBk and previously set threshold values for the lightness of the respective colors are expressed as WLth and BkLth, and the chroma and the hue angles are expressed in the similar manner. In this case, whether a suitable candidate is present is determined using expressions (15) to (17).

(ΔLW≦WLth)&(ΔLBk≦BkLth) Expression (15)

(ΔCW≦WCth)&(ACBk≦BkCth) Expression (16)

(ΔHW≦WHth)&(ΔHBk≦BkHth) Expression (17)

In a case where all the expressions (15) to (17) are satisfied, it is determined that a suitable candidate is present, the color reproduction target value candidate is extracted, and the processing proceeds to step S907. Whereas, in a case where at least one of the expressions (15) to (17) is not satisfied, it is determined that no suitable candidate is present, and the processing proceeds to step S921. Note that, for example, as for the priority gradation reproduction in the user creation condition, in a case where the selection item by the user is the color-emphasized reproduction, the threshold values used in the step are set to values lager than those used in step S1703, which is described later, for the dark part-high lightness gradation emphasis, so that the threshold value ranges are further wider.

### <S906>

At step S906, the color reproduction target value candidate extracting unit 405 extracts a color reproduction target value candidate for the dark part-high lightness gradation-emphasized reproduction. Here, processing performed at step S906 will be explained with reference to a flowchart FIG. 9C.

### <S1703>

At step S1703, the color reproduction target value candidate extracting unit 405 determines whether a suitable candidate is present by a method similar to that at step S1702, and extracts the candidate in a case of being present. Note that, threshold values used in the step are smaller than those used at step S1702, and the threshold value ranges are further narrower. As a result of determination, in a case where the suitable candidate is present, the processing proceeds to step S1704, whereas in a case where no suitable candidate is present, the processing proceeds to step S921.

### <S1704>

At step S1704, the color reproduction target value candidate extracting unit 405 determines whether a suitable candidate is present in the candidates extracted at step S1703 by a method similar to that at step S1701, and extracts the candidate in a case of being present. Note that, threshold values used in the step are larger than those used at step S1701, and the threshold value ranges are further wide. As a result of determination, in a case where the suitable candidate is present, the processing proceeds to step S907, whereas in a case where no suitable candidate is present, the processing proceeds to step S921.

### <S907>

At step S907, the color reproduction target value candidate extracting unit 405 compares a color reproduction target value corresponding to the candidate extracted at step S905 or step S906 with an internal color difference in the color reproduction region of the output device, and extracts a candidate of which average color difference is not more than a threshold value. In other words, in a case where an average color difference is expressed as ΔE and a previously set threshold value of average color difference is expressed as Eth, whether a suitable candidate is present is determined using an expression (18).

ΔEW≦Eth Expression (18)

Ina case where the expression (18) is satisfied, the processing proceeds to step S908, whereas in a case where the expression (18) is not satisfied, the processing proceeds to step S921.

In the present embodiment, it is considered that ΔE94 is preferably used as a color difference in order to select a color reproduction target value close to the shape of the color reproduction region of the output device, however, another color difference such as ΔE76, a lightness differences, a luminance difference, or the like may be used. Moreover, at the time when one candidate remains during the processes at step S902 to s907, the processing may skip the subsequent process(es), and proceed to step S908.

### <S908>

At step S908, the color profile creating unit 204 notifies the user of characteristics included in a color profile created for the candidate extracted at step S907. Specifically, the color profile creating unit 204 calculates the area and the shape of a color reproduction region, the internal color reproducibility, gradations of R, G, B, C, M, and Y, and Gray, and the chromaticity that represent characteristics of the color profile and displays them in the display unit 207 to provide the characteristics to the user. On the UI in FIG. 10, the user sets a candidate desired to be checked in a candidate setting field 1031, sets a hue desired to be checked in a hue setting field 1034, and then presses a display button 1039. In response to this, the characteristics of the color profile are displayed in a color reproduction region display unit 1035, an internal color reproduction display unit 1036, a gradation display unit 1037, and a chromaticity display unit 1038 (see a column of “UI” described later for details).

### <S909>

At step S909, the color profile creating unit 204 determines whether a color reproduction target value that satisfies an image quality preferable for the user is present based on an instruction by the user. Specifically, the user sets a candidate through the candidate setting field 1031 in FIG. 10, and checks whether a color reproduction target value that satisfies the desired image quality is present from the characteristics displayed on the UI. In a case of being present, the user presses a profile creation start button 1032, and the processing proceeds to step S910. Ina case of not being present, the user presses a cancel button 1033, the processing proceeds to step S921.

### <S910>

At step S910, the color reproduction target value candidate extracting unit 405 acquires the color reproduction target value candidate that the user determines as the most preferable as a color reproduction target value.

### <S921>

At step S921, the color profile creating unit 204 determines whether the color profile creation condition is set again. This step is executed in a case where no color reproduction target value candidate that matches the user creation condition is present. The host computer 200 notifies the user that no suitable color reproduction target value candidate is present on the UI. Moreover, the host computer 200 checks with the user for whether a user creation condition again using the UI in FIG. 10 is set, and then a color reproduction target value is searched again. In a case where the user searches a color reproduction target value again, after the user sets a user creation condition again on the UI, the processing returns to step S901. In a case where the user does not search a color reproduction target value again user, the processing is finished.

At the abovementioned steps s1701 and s1703, described is an example where, in order to determine a color reproduction target value close to the shape of the color reproduction region of the output device, each value in the primary data is determined as to whether the value is within or outside a predetermined threshold value range, so that the color reproduction target value is selected from the color reproduction target value candidates. In the example, out of the color reproduction target value candidates stored in advance, the shape and the size are determined based on the primary data and a candidate in which each difference is not more than the predetermined threshold value is searched. However, a candidate may be searched by setting a threshold value relative to a total sum (ΔEW+ΔEBk+ΔER+ΔEG+ΔEB+ΔEC+ΔEM+ΔEY) of the color differences of the respective colors, the maximum color difference, a volume of the color reproduction region surrounded by the primary data, or the like.

Moreover, at the abovementioned steps s1701 and s1703, in a case where the color measurement value of the output device is extremely close to primary data of the selected candidate, the processing can proceed to step S907 not through the subsequent steps s1702 and s1704. Specifically, two threshold values of a first threshold value and a second threshold value are set for each threshold value in the explanation for the abovementioned step S1701. Further, in a case where the difference is not more than the first threshold value, the processing may proceed to step S907, in a case where the difference is not less than the first threshold value and less than second threshold value the processing may proceed to step S1702 or s1704, and in a case where the difference is not less than the second threshold value, the processing may proceed to step S921.

### (UI)

Next, with reference to FIG. 10, an example of a UI corresponding to a color profile creation program according to the present embodiment will be explained. The UI illustrated in FIG. 10 includes an input/output setting unit 1010, a condition setting unit 1020, and a creating unit 1030. The input/output setting unit 1010 includes an output device color reproduction region setting field 1011 and the color profile name setting field 1012. The condition setting unit 1020 includes the usage purpose setting field 1021, the input color space setting field 1022, the priority gradation reproduction setting field 1023, and the search start button 1024. The creating unit 1030 includes the candidate setting field 1031, the profile creation start button 1032, and the cancel button 1033. Moreover, the creating unit 1030 includes the hue setting field 1034, the color reproduction region display unit 1035, the internal color reproduction display unit 1036, the gradation display unit 1037, the chromaticity display unit 1038, and the display button 1039.

A user sets a color reproduction region of an output device for which the user desires to create a color profile in the output device color reproduction region setting field 1011, and sets a file name of the color profile to be created through the color profile name setting field 1012. Thereafter, the user sets creation conditions for the color profile in the condition setting unit 1020. Specifically, the user firstly sets an item that is the closest to a usage purpose and a request of the user, from selection items (for example, photograph, wedding, silver salt, poster, scenery, and the like) in a pull-down menu of the usage purpose setting field 1021. The user then sets a color space from selection items (for example, sRGB, AdobeRGB, and the like) in a pull-down menu of the input color space setting field 1022. The user then sets gradation reproduction with priority from selection items (for example, dark part-high lightness gradation emphasis, color reproduction emphasis, and the like) in a pull-down menu of the priority gradation reproduction setting field 1023, and thereafter, presses the search start button 1024.

In response to this, based on the color reproduction region of the output device set in the output device color reproduction region setting field 1011 and the condition set in the condition setting unit 1020, the color reproduction target value candidate extracting unit 405 in FIG. 4 extracts at least one candidate from the color reproduction target value storage unit 406. Candidates (for example, a candidate 1, a candidate 2, and the like) are displayed in a pull-down menu of the candidate setting field 1031 only for the number of the candidates extracted by the color reproduction target value candidate extracting unit 405, and the user sets a candidate desired to be checked out of them. Further, the user sets the hue of a color profile desired to be checked from selection items (R, G, B, C, M, Y, Gray, or the like) in a pull-down menu of the hue setting field 1034, and presses the display button 1039.

In response to this, characteristics of the color profile in a case where the color profile is created by the set candidate are displayed on the UI. The color reproduction region display unit 1035 displays a color reproduction region of the color profile and the color reproduction region of the output device. This allows the user to check the areas and the shapes of the color reproduction regions. The internal color reproduction display unit 1036 displays an orthogonal graph using the lightness and the chroma of the designated hue as axes. This allows the user to check the internal color reproducibility of the color profile. The gradation display unit 1037 displays a graph illustrating the gradation of the designated hue. The chromaticity display unit 1038 displays a graph illustrating the chromaticity of the designated hue. The user checks characteristics of a color profile of each of the candidates, sets a color reproduction target value for creating a color profile that satisfies a desired image quality through the pull-down menu of the candidate setting field 1031, and then presses the profile creation start button 1032. In response to this, the color reproduction target value is determined, and the color profile is created.

In the present embodiment, a case where four analyzed results are displayed on the UI is explained as an example. However, another analyzed result (for example, an internal color difference, or the like) considered to be necessary for determining a color profile may be separately displayed on the UI. Moreover, a hue angle (0°, 90°, 180°, 270° or the like) may be set in the hue setting field 1034. In addition, the selection items in the pull-down menus of the input color space setting field 1022 and the priority gradation reproduction setting field 1023 in the condition setting unit 1020 are not limited to those described above, but the number of the selection items may be increased.

In the present embodiment, the user sets a usage purpose to narrow down the range of a color reproduction target value in order to show a color profile in accordance with the usage purpose or the scene. However, without selection of a usage purpose by the user, it is possible to show a color profile in which the gradation color reproducibility in the dark part and the high lightness region and the chroma gradation reproducibility of a chromatic color are held. In addition, for the narrowing down with higher accuracy, a creation condition other than the creation conditions of the abovementioned three items (usage purpose, input color space, and priority gradation reproduction) are added to allow the user to set the creation condition.

### Second Embodiment

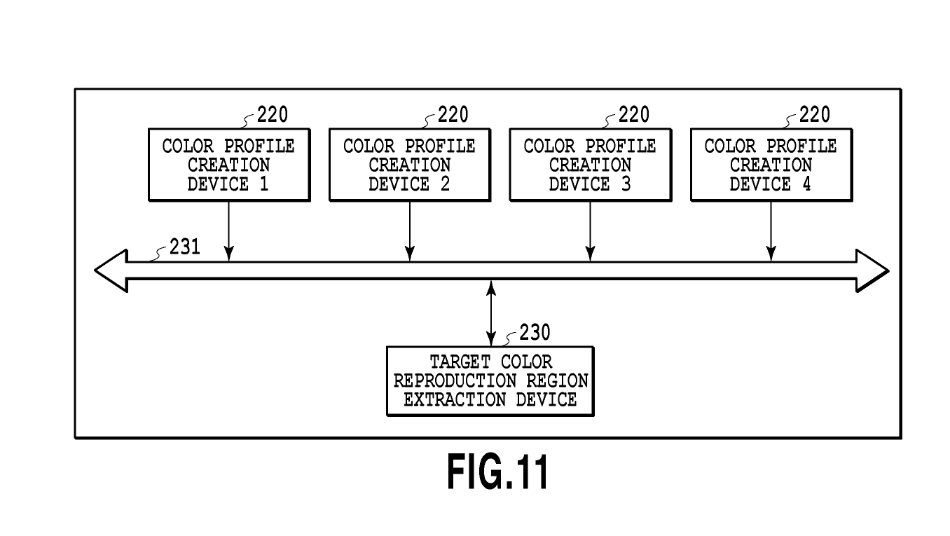

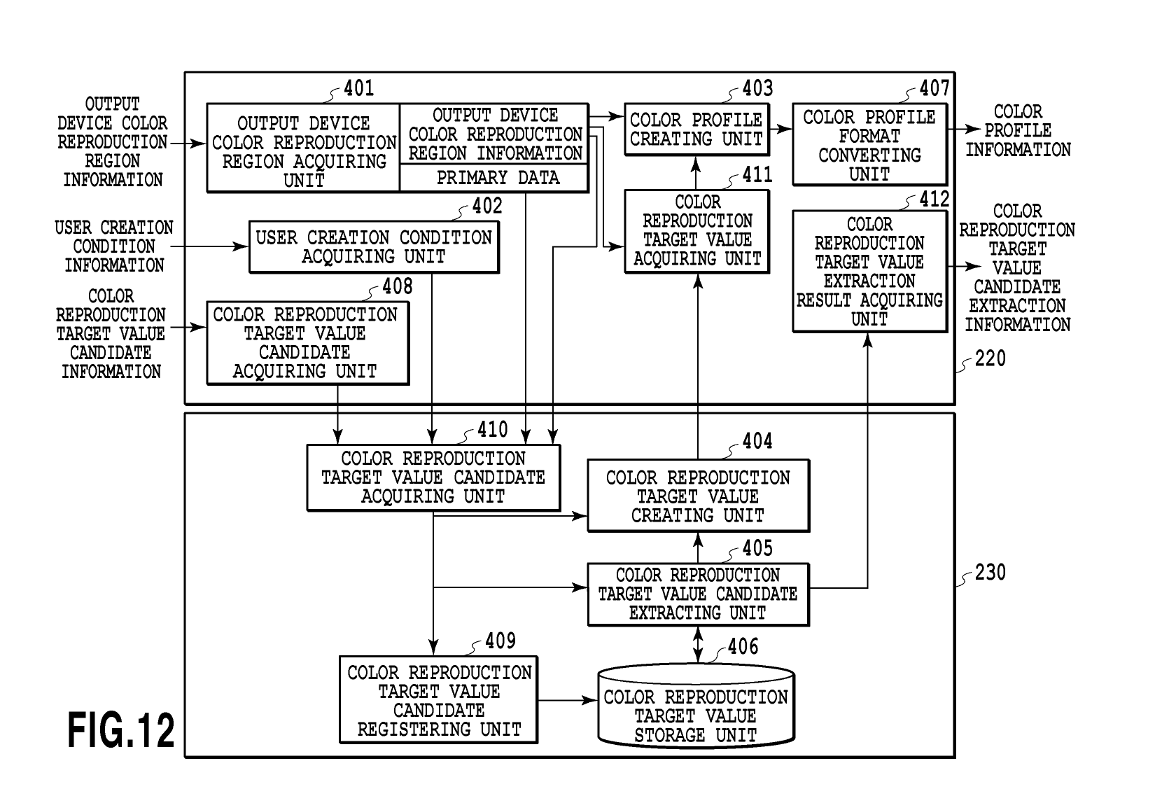

FIG. 11 is a block diagram illustrating a configuration of a part of a system according to a second embodiment, and FIG. 12 is a block diagram illustrating a detailed configuration of a color profile creation device 220 and a target color reproduction region extraction device 230 according to the second embodiment. Hereinafter, portions different from those in the first embodiment will be mainly explained (see FIG. 4).

The color profile creation device 220 includes the output device color reproduction region acquiring unit 401, the user creation condition acquiring unit 402, the color profile creating unit 403, the color profile format converting unit 407, and the color reproduction target value candidate acquiring unit 408. Moreover, the color profile creation device 220 includes a color reproduction target value acquiring unit 411 and a color reproduction target value extraction result acquiring unit 412.

The target color reproduction region extraction device 230 includes the color reproduction target value creating unit 404, the color reproduction target value candidate extracting unit 405, the color reproduction target value storage unit 406, the color reproduction target value candidate registering unit 409, and a color reproduction target value candidate acquiring unit 410.

Output device color reproduction region information acquired by the color profile creation device 220 is transmitted to the output device color reproduction region acquiring unit 401. The output device color reproduction region acquiring unit 401 transmits the output device color reproduction region information to the color profile creating unit 403 and the color reproduction target value acquiring unit 411.

Moreover, the output device color reproduction region acquiring unit 401 further transmits the output device color reproduction region information to the color reproduction target value candidate acquiring unit 410 in the target color reproduction region extraction device 230 via a network 231 in FIG. 11. The color reproduction target value candidate acquiring unit 410 then transmits the output device color reproduction region information to the color reproduction target value creating unit 404 and the color reproduction target value candidate extracting unit 405.

The user creation condition acquiring unit 402 acquires user creation condition information, and transmits the user creation condition information to the color reproduction target value candidate acquiring unit 410 via the network 231. The color reproduction target value candidate acquiring unit 410 transmits the transmitted user creation condition information to the color reproduction target value creating unit 404 and the color reproduction target value candidate extracting unit 405.

The color reproduction target value candidate extracting unit 405 extracts a candidate suitable for a user creation condition from the color reproduction target value storage unit 406. Moreover, the color reproduction target value candidate extracting unit 405 transmits color reproduction target value candidate extraction information indicating an extraction result to the color reproduction target value extraction result acquiring unit 412 via the network 231 to show the extraction result to a user. The user then selects a color reproduction target value candidate that is the closest to a preferable color profile. The user creation condition acquiring unit 402 acquires information relating to the color reproduction target value candidate selected by the user. The user creation condition acquiring unit 402 transmits the information to the color reproduction target value candidate acquiring unit 410 via the network 231. The color reproduction target value candidate acquiring unit 410 transfers the transmitted information to the color reproduction target value candidate extracting unit 405. The color reproduction target value creating unit 404 then creates a color reproduction target value based on a color reproduction target value of the candidate selected by the user, and transmits the created color reproduction target value to the color reproduction target value acquiring unit 411 via the network 231. The color reproduction target value acquiring unit 411 transfers the transmitted color reproduction target value to the color profile creating unit 403. The color profile format converting unit 407 converts the format of a color profile that is data obtained from the transferred data by being subjected to mapping processing by the color profile creating unit 403. The color profile creation device 220 outputs color profile information including the color profile after the format conversion.

In a case where the color profile is registered as a new color reproduction target value candidate, the color profile is sent to the color reproduction target value candidate registering unit 409 via the color reproduction target value candidate acquiring unit 408, the network 231, and the color reproduction target value candidate acquiring unit 410. The color reproduction target value candidate registering unit 409 determines whether the color reproduction target value indicating the color profile is additionally registered in the color reproduction target value storage unit 406. As a result of determination, in a case where the color reproduction target value is registered, the color profile is sent to and stored in the color reproduction target value storage unit 406.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment (s) and/or that includes one or more circuits (e.g., application specific integrated circuit (ASIC)) for performing the functions of one or more of the above-described embodiment (s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment (s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-009610, filed Jan. 22, 2014, which is hereby incorporated by reference wherein in its entirety.

What is claimed is:

1. An apparatus that creates a color profile used for converting input data on an input color space into output data on an output color space for an output device, the apparatus comprising:
a color reproduction target value acquiring unit configured to acquire a plurality of color reproduction target values corresponding to target of color to be reproduced by the output device;
a color reproduction region acquiring unit configured to acquire a color reproduction region of the output device;
a condition acquiring unit configured to acquire a condition to select the color reproduction target value;
a selecting unit configured to select at least one color reproduction target value that satisfy the condition out of the plurality of color reproduction target values; and
a color profile creating unit configured to create, based on the acquired color reproduction region of the output device acquired by the color reproduction region acquiring unit and the at least one color reproduction target value selected by the selecting unit, the color profile in which the color reproduction target value is present in the color reproduction region of the output device.

2. The apparatus according to claim 1, wherein the color profile creating unit creates the color profile by performing mapping based on the condition.

3. The apparatus according to claim 1, wherein the condition includes at least one of a usage purpose, an input color space and a priority gradation reproduction.

4. The apparatus according to claim 1, wherein the color reproduction region of the output device is acquired by subjecting a patch image created using a known color material activity ratio to printing and color measurement.

5. The apparatus according to claim 1, wherein the selecting unit acquires chroma in an a*b*region with a characteristic difference between different input color spaces and at a predetermined lightness, calculates a chroma ratio using the acquired chroma, and selects the color reproduction target value in which the calculated chroma ratio falls within a predetermined threshold value range.

6. The apparatus according to claim 1, wherein the selecting unit calculates differences in R, G, B, C, M, Y, W, and Bk between the lightness, the chroma, and a hue angle (LCH) in the color reproduction region of the output device and the LCH in each of the plurality of color reproduction target values, and selects the color reproduction target value in which at least one of the calculated differences is not more than a threshold value.

7. The apparatus according to claim 1, wherein the condition acquiring unit acquires the condition based on input by a user.

8. The apparatus according to claim 7, further comprising receiving unit configured to receive input relating the condition by the user.

9. The apparatus according to claim 1, wherein the selecting unit configured to select a plurality of color reproduction target values that satisfy the condition out of the plurality of color reproduction target values.

10. The apparatus according to claim 9, further comprising presenting unit configured to cause a presenting device to present the plurality of color target values selected by the selecting unit to a user; and wherein the color profile creating unit creates the color profile based on the acquired color reproduction region of the output device and a color reproduction target value selected by the user from the plurality of color target values presented to the user.

11. The apparatus according to claim 1, wherein the output device is an inkjet printer.

12. A method of creating a color profile used for converting input data on an input color space into output data on an output color space for an output device, the method comprising the steps of:
acquiring a plurality of color reproduction target values corresponding to target of color to be reproduced by the output device;
acquiring a color reproduction region of the output device;
acquiring a condition to select the color reproduction target value;
selecting at least one color reproduction target value that satisfy the condition out of the plurality of color reproduction target values; and
creating, based on the acquired color reproduction region of the output device acquired in the color reproduction region acquiring step and the at least one color reproduction target value selected in the selecting step, the color profile in which the color reproduction target value is present in the color reproduction region of the output device.

13. The method according to claim 12, wherein, in the creating step, the color profile is created by performing mapping based on the condition.

14. The method according to claim 12, wherein the condition includes at least one of a usage purpose, an input color space and a priority gradation reproduction.

15. The method according to claim 12, wherein the color reproduction region of the output device is acquired by subjecting a patch image created using a known color material activity ratio to printing and color measurement.

16. The method according to claim 12, wherein, in the condition acquiring step, the condition is acquired based on input by a user.

17. The method according to claim 12, wherein, in the selecting step, a plurality of color reproduction target values that satisfy the condition are selected out of the plurality of color reproduction target values.

18. The method according to claim 17, further comprising presenting step of causing a presenting device to present the plurality of color target values selected in the selecting step to a user; and wherein, in the creating step, the color profile is crated based on the acquired color reproduction region of the output device and a color reproduction target value selected by the user from the plurality of color target values presented to the user.

19. The method according to claim 12, wherein the output device is an inkjet printer.

20. A non-transitory computer readable storage medium storing a program to causes a computer to execute the method according to claim 12.

21. An apparatus used for creating a color profile used for converting input data on an input color space into output data on an output color space for an output device, the apparatus comprising:
an acquiring unit configured to acquire a result of reading a color patch printed on a print medium by the output device;
a condition acquiring unit configured to acquire a condition to determine a color reproduction target value corresponding to target of color to be reproduced by the output device based on input by a user;
a presenting control unit configured to cause a presenting device to present at least one color reproduction target value, for creating the color profile, that satisfy the condition acquired by the condition acquiring unit.

22. The apparatus according to claim 21, wherein the output device is an inkjet printer.

23. A method used for creating a color profile used for converting input data on an input color space into output data on an output color space for an output device, the method comprising:
a result acquiring step of acquiring a result of reading a color patch printed on a print medium by the output device;
a condition acquiring step of acquiring a condition to determine a color reproduction target value corresponding to target of color to be reproduced by the output device based on input by a user;
a presenting control step of causing a presenting device to present at least one color reproduction target value, for creating the color profile, that satisfy the condition acquired in the condition acquiring step.

24. The method according to claim 23, wherein the output device is an inkjet printer.

25. A non-transitory computer readable storage medium storing a program to causes a computer to execute the method according to claim 23.
